(19) United States
(12) Patent Application Publication
(10) Pub. No.: US 2015/0153564 A1
(43) Pub. Date: Jun. 4, 2015

(54) WAVELENGTH VARIABLE INTERFERENCE FILTER, OPTICAL MODULE, AND ELECTRONIC DEVICE

(71) Applicant: Seiko Epson Corporation, Tokyo (JP)

(72) Inventors: Akira SANO, Shiojiri (JP); Tomohiro MAKIGAKI, Matsumoto (JP); Kazunori SAKURAI, Chino (JP)

(21) Appl. No.: 14/556,651

(22) Filed: Dec. 1, 2014

(30) Foreign Application Priority Data
Dec. 2, 2013 (JP) 2013-248931

(51) Int. Cl. G02B 26/00; G02B 5/20

(52) U.S. Cl. CPC G02B 26/001; G02B 5/201; G02B 5/0825

(57) ABSTRACT

A wavelength variable interference filter includes a plurality of filter units each of which includes a pair of reflecting films facing each other and a gap changing unit changing an interval between the pair of reflecting films. The plurality of filter units are two-dimensionally disposed with respect to an arrangement surface parallel to a reflecting surface of the reflecting film, and reflecting films of other filter units disposed at locations different from those on a first virtual straight line, intersecting a predetermined direction (first direction) along the arrangement surface, are disposed so as to overlap a portion of the reflecting films on the first virtual straight line without gaps therebetween between two reflecting films adjacent with a predetermined interval therebetween along the first virtual straight line, when seen from the predetermined direction (first direction).

### BACKGROUND

1. Technical Field

The present invention relates to a wavelength variable interference filter which acquires light of a specific wavelength, an optical module, and an electronic device.

2. Related Art

Hitherto, there is a known interference filter that has a pair of reflecting films facing each other, and selects light of a predetermined wavelength from light of a measurement target and emits the selected light by changing a distance (gap size) between the reflecting films (for example, see JP-A-11-142752).

In the interference filter disclosed in JP-A-11-142752, an electrode is disposed on each reflecting film, and a voltage is applied between the electrodes, and thus it is possible to change a gap size between the reflecting films. In addition, a dielectric multilayer film is used as the reflecting film, and thus it is possible to transmit light having a small half value width (high resolution) of a spectrum.

Incidentally, the above-mentioned wavelength variable interference filter as disclosed in JP-A-11-142752 may be applied to an apparatus such as, for example, a spectroscopic camera which acquires a spectroscopic image. In such a spectroscopic camera, there is a requirement for acquiring a spectroscopic image within a wide viewing angle. In this case, it is also considered that an area of each of the pair of reflecting films be increased and that an effective region where interference of light occurs multiple times be increased. However, when the area of the reflecting film is increased, there is a tendency for the reflecting film to bend to that extent. When the reflecting film bends, a spectral resolution in the wavelength variable interference filter is decreased, and thus there is a problem in that a highly accurate spectroscopic image cannot be acquired.

### SUMMARY

An advantage of some aspects of the invention is to provide a wavelength variable interference filter capable of spectral resolution over a wide area while maintaining high resolution, an optical module, and an electronic device.

An aspect of the invention is directed to a wavelength variable interference filter including a plurality of filter units each of which includes a pair of reflecting films facing each other and a gap changing unit changing an interval between the pair of reflecting films. The plurality of filter units are two-dimensionally disposed with respect to an arrangement surface parallel to a reflecting surface of the reflecting film, and reflecting films of other filter units disposed at locations different from those on a first virtual straight line, intersecting a predetermined direction along the arrangement surface, are disposed to overlap a portion of the reflecting films on the first virtual straight line without gaps therebetween between two reflecting films adjacent with a predetermined interval therebetween along the first virtual straight line, when seen from the predetermined direction.

According to the aspect of the invention, the plurality of filter units capable of changing a wavelength of light to be emitted are provided on the arrangement surface. In addition, reflecting films of other filter units, which are not present on the first virtual straight line intersecting the predetermined direction along the arrangement surface, are disposed between the reflecting films of two neighboring filter units disposed along the first virtual straight line when seen from the predetermined direction (scanning direction), and the reflecting films of other filter units are disposed so as to overlap each other without gaps therebetween. That is, when the reflecting films of the filter units are projected with respect to the first virtual straight line from the scanning direction along the predetermined direction, the reflecting films are disposed without gaps therebetween.

For this reason, for example, when spectral dispersion is performed while relatively moving the wavelength variable interference filter with respect to a measurement target in the predetermined direction as a scanning direction, it is possible to perform spectrometry without a gap. That is, the wavelength variable interference filter includes the plurality of filter units, and the reflecting films of the filter units are disposed without gaps therebetween. Thus, when spectral dispersion is performed using the wavelength variable interference filter, it is possible to reliably spectrally resolve a wide area.

In the wavelength variable interference filter according to the aspect of the invention, it is preferable that the plurality of filter units are disposed so as to have a planar filling structure when seen from a direction perpendicular to the arrangement surface.

According to the aspect of the invention with this configuration, since the plurality of filter units have a planar filling structure in the arrangement surface, the reflecting films are disposed without gaps therebetween even when the reflecting films are projected from any direction along the arrangement surface. Therefore, even when the wavelength variable interference filter is relatively moved with respect to a measurement target in any scanning direction, spectrometry can be performed without a gap.

In the wavelength variable interference filter according to the aspect of the invention, it is preferable that each of the plurality of filter units has a regular hexagonal shape in a planar view seen from the direction perpendicular to the arrangement surface, and the filter units are disposed so as to have a honeycomb structure as the planar filling structure.

According to the aspect of the invention with this configuration, each of the plurality of filter units is constituted by a regular hexagon, the filter units being disposed so as to have a honeycomb structure. Thus, it is possible to efficiently dispose the plurality of filter units without gaps therebetween.

In the wavelength variable interference filter according to the aspect of the invention, it is preferable that each of the plurality of filter units includes a first substrate on which one of the pair of reflecting films is provided, a second substrate on which the other one is provided, and a bonding portion that bonds the first substrate and the second substrate, and the bonding portion is provided along sides of the regular hexagonal shape of each of the filter units.

According to the aspect of the invention with this configuration, the bonding portion is provided along sides of the regular hexagonal shape of each of the plurality of filter units. In such a configuration, the first substrate and the second substrate are bonded to each other at the sides of the regular hexagonal shape, and thus it is possible to achieve an improvement in bonding strength.

In the wavelength variable interference filter according to the aspect of the invention, it is preferable that the bonding portion is provided at an intersection between the sides of the regular hexagonal shape.

According to the aspect of the invention with this configuration, the bonding portion is provided at an intersection between the sides of the regular hexagonal shape. In such a configuration, the bonding region is minimized, and thus it is possible to improve area use efficiency in the wavelength variable interference filter. That is, it is possible to reliably perform spectral dispersion of a wider area by using the wavelength variable interference filter.

In the wavelength variable interference filter according to the aspect of the invention, it is preferable that each of the pair of reflecting films of each of the plurality of filter units has a regular hexagonal shape corresponding to the regular hexagonal shape of each of the filter units in a planar view seen from the direction perpendicular to the arrangement surface.

According to the aspect of the invention with this configuration, each of the pair of reflecting films of each of the plurality of filter units is a regular hexagon corresponding to the shape of each filter unit. In such a configuration, when an interval (gap size) between the reflecting films is changed using the gap changing unit, a portion in which there is a high probability of warpage or deflection being caused in the reflecting films is limited to the vicinity of the vertex of the regular hexagon of each reflecting film. Therefore, an effective area in which the reflecting film functions is increased, and thus it is possible to increase area use efficiency.

In the wavelength variable interference filter according to the aspect of the invention, it is preferable that the plurality of filter units include the multiple types of filter unit having different initial sizes for an interval between the pair of reflecting films.

According to the aspect of the invention with this configuration, the multiple types of filter unit having different initial sizes (initial gaps) for an interval between the pair of reflecting films are provided. In such a configuration, wavelength scanning ranges of the respective multiple types of filter unit can be made different from each other, and thus it is possible to set a wide bandwidth for a spectroscopic object by using one wavelength variable interference filter. For example, the first filter unit having an initial gap of 700 nm between the reflecting films, the second filter unit having an initial gap of 1000 nm therebetween, and the third filter unit having an initial gap of 1300 nm therebetween may be used, and it is possible to spectrally resolve a wavelength region of 400 nm to 1300 nm by using one wavelength variable interference filter when a wavelength scanning range of each filter unit is 300 nm.

In the wavelength variable interference filter according to the aspect of the invention, it is preferable that each of the pair of reflecting films is constituted by a dielectric multilayer film.

According to the aspect of the invention with this configuration, since a dielectric multilayer film having high reflectance with respect to a predetermined wavelength region is used as each reflecting film, a half value width of light emitted from the wavelength variable interference filter becomes smaller, and thus it is possible to improve resolution.

In addition, when a dielectric multilayer film is used as the reflecting film, a wavelength scanning range becomes narrow. However, as in the above-mentioned aspect of the invention, it is also possible to spectrally resolve a wide band by using the plurality of filter units having different initial gaps. Therefore, in this case, it is possible to achieve both high resolution and a wide band.

In the wavelength variable interference filter according to the aspect of the invention, it is preferable that each of the plurality of filter units includes a first substrate on which one of the pair of reflecting films is provided, and a second substrate on which the other one is provided, the gap changing unit includes a first electrode provided in the first substrate, and a second electrode which is provided in the second substrate and faces the first electrode, the first substrate is provided with a first connection electrode connected to the first electrode, the first connection electrode is provided from the first electrode to a substrate outer peripheral portion of the first substrate, the second substrate is provided with a second connection electrode connected to the second electrode, and the second connection electrode is provided from the second electrode to a substrate outer peripheral portion of the second substrate.

According to the aspect of the invention with this configuration, the gap changing unit is constituted by the first electrode provided in the first substrate and the second electrode provided in the second substrate. The first connection electrode and the second connection electrode are connected to the first electrode and the second electrode, respectively, and are extracted to the substrate outer peripheral portion.

In such a configuration, it is possible to change a gap size by individually driving the gap changing units in the filter units.

In the wavelength variable interference filter according to the aspect of the invention, it is preferable that the first connection electrode connects the first electrodes of the filter units which are disposed along a predetermined first direction in a planar view seen from the direction perpendicular to the arrangement surface, and the second connection electrode connects the second electrodes of the respective filter units which are disposed along a second direction intersecting the first direction in a planar view seen from the direction perpendicular to the arrangement surface.

According to the aspect of the invention with this configuration, a voltage is sequentially applied to the first connection electrode and the second connection electrode, and thus it is possible to drive the gap changing units using a passive matrix method. In this case, it is possible to individually drive the filter units efficiently. In addition, an area occupied by the connection electrodes can be reduced as compared with a case where the connection electrodes are individually connected to the gap changing units of the filter units. Thus, it is possible to increase areas of the reflecting films and to achieve an improvement in area use efficiency.

In the wavelength variable interference filter according to the aspect of the invention, it is preferable that each of the pair of reflecting films has conductivity and a reflecting film connection electrode is connected to each reflecting film.

According to the aspect of the invention with this configuration, each of the pair of reflecting films has conductivity, and the reflecting films are connected to each other by the reflecting film connection electrode. In such a configuration, the reflecting film can function as, for example, a driving electrode or a capacitance detecting electrode. When the reflecting film functions as the driving electrode, it is possible to use the reflecting film as a gap changing unit, to further simplify the configuration of the filter unit, and to achieve an improvement in area efficiency. In addition, when the reflecting film functions as the capacitance detecting electrode, it is possible to detect the gap size between the reflecting films by detecting capacitance between the pair of reflecting films. In this case, it is possible for light of a desired wavelength to be accurately emitted from the wavelength variable interference filter by performing the feedback control of the gap changing unit. Further, the reflecting film connection electrode is connected to a ground circuit so as to be grounded, and thus it is possible to allow charge of the reflecting films to escape and to suppress the fluctuation of the gap between the reflecting films due to Coulomb's forces and the like.

Another aspect of the invention is directed to an optical module including a wavelength variable interference filter that includes a plurality of filter units each of which includes a pair of reflecting films facing each other and a gap changing unit changing an interval between the pair of reflecting films, the plurality of filter units being two-dimensionally disposed with respect to an arrangement surface parallel to a reflecting surface of the reflecting film, and reflecting films of other filter units disposed at locations different from those on a first virtual straight line, intersecting a predetermined direction along the arrangement surface, being disposed to overlap a portion of the reflecting films on the first virtual straight line without gaps therebetween between two reflecting films adjacent with a predetermined interval therebetween along the first virtual straight line, when seen from the predetermined direction; and a light-receiving unit that receives light emitted from the wavelength variable interference filter.

According to the aspect of the invention, the optical module includes the above-mentioned wavelength variable interference filter. Therefore, also in the optical module including the wavelength variable interference filter, a spectroscopic image for a wide area which is emitted from the wavelength variable interference filter can be received by the light-receiving unit, and thus it is possible to acquire a highly accurate spectroscopic image.

In the optical module according to the aspect of the invention, it is preferable that the plurality of filter units include multiple types of filter unit having different initial sizes for an interval between the pair of reflecting films, sets each including a predetermined number of multiple types of filter unit are disposed in a matrix as pixel filters on the arrangement surface, and the light-receiving unit is provided with a plurality of pixels corresponding to each of the multiple types of filter unit of each of the pixel filters.

Similarly to the above-mentioned aspect of the invention, according to the aspect of the invention with this configuration, it is possible to make wavelength scanning ranges different from each other in the multiple types of filter unit and to emit light of different wavelength regions. In addition, sets each including a predetermined number (for example, one) of multiple types of filter unit may be used as pixel filters, and light beams emitted from the pixel filters be received in one pixel of the light-receiving unit corresponding to each of the pixel filters, and thus it is possible to efficiently acquire a spectroscopic image. In addition, it is possible to derive a spectrum for one pixel of the spectroscopic image from data of the amount of received light of each pixel in the light-receiving unit.

Still another aspect of the invention is directed to an electronic device including a wavelength variable interference filter that includes a plurality of filter units each of which includes a pair of reflecting films facing each other and a gap changing unit changing an interval between the pair of reflecting films, the plurality of filter units being two-dimensionally disposed with respect to an arrangement surface parallel to a reflecting surface of the reflecting film, and reflecting films of other filter units disposed at locations different from those on a first virtual straight line, intersecting a predetermined direction along the arrangement surface, being disposed overlap a portion of the reflecting films on the first virtual straight line without gaps therebetween between two reflecting films adjacent with a predetermined interval therebetween along the first virtual straight line, when seen from the predetermined direction; and a control unit that controls the wavelength variable interference filter.

Here, the electronic device can include, for example, a light measurement device that analyzes the chromaticity and brightness of incident light on the basis of an electrical signal output from the above-mentioned optical module, a gas detector that detects an absorption wavelength of gas and identifies the type of gas, an optical communication device that acquires data included in a wavelength of light received, a spectroscopic camera, and the like.

According to the aspect of the invention, it is possible to acquire a spectroscopic image of a wide measurement range with a high level of accuracy on the basis of light emitted from the above-mentioned wavelength variable interference filter and to perform various types of highly-accurate processes on the basis of the spectroscopic image.

### BRIEF DESCRIPTION OF THE DRAWINGS

The invention will be described with reference to the accompanying drawings, wherein like numbers reference like elements.

FIG. 1 is a block diagram showing a schematic configuration of a spectrometry apparatus using a wavelength variable interference filter according to a first embodiment.

FIG. 2 is a plan view showing one schematic configuration of the wavelength variable interference filter according to the first embodiment.

FIG. 3 is a cross-sectional diagram of the wavelength variable interference filter taken along line III-III of FIG. 2.

FIG. 4 is a cross-sectional diagram of the wavelength variable interference filter taken along line IV-IV of FIG. 2.

FIG. 5 is a plan view showing a schematic configuration of a fixed substrate of the wavelength variable interference filter according to the first embodiment.

FIG. 6 is a plan view showing a schematic configuration of a movable substrate of the wavelength variable interference filter according to the first embodiment.

FIG. 7 is a plan view showing an example in which filter units of a wavelength variable interference filter according to a second embodiment are disposed.

FIGS. 8A to 8C are cross-sectional diagrams of the wavelength variable interference filter taken along line VIII-VIII of FIG. 7.

FIG. 9 is a block diagram showing a schematic configuration of a colorimeter which is another example of an electronic device according to the invention.

FIG. 10 is a schematic diagram of a gas detector which is another example of the electronic device according to the invention.

FIG. 11 is a block diagram showing a control system of the gas detector of FIG. 10.

FIG. 12 is a block diagram showing a schematic configuration of a food analyzer which is another example of the electronic device according to the invention.

FIG. 13 is a schematic diagram showing a schematic configuration of a spectroscopic camera which is another example of the electronic device according to the invention.

### DESCRIPTION OF EXEMPLARY EMBODIMENTS

Hereinafter, a first embodiment of the invention will be described with reference to the accompanying drawings.

### Configuration of Spectrometry Apparatus

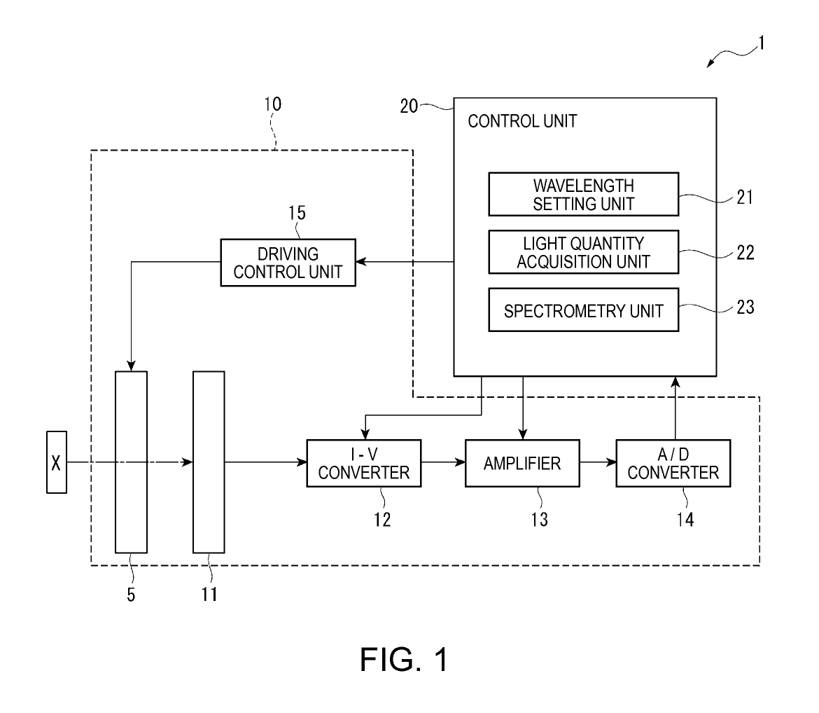

FIG. 1 is a block diagram showing a schematic configuration of a spectrometry apparatus using a wavelength variable interference filter according to the first embodiment.

A spectrometry apparatus 1 is an example of an electronic device according to the invention, and includes an optical module 10 and a control unit 20 that processes a signal output from the optical module 10 as shown in FIG. 1. The spectrometry apparatus 1 relatively moves the optical module 10 with respect to a measurement target X in a predetermined scanning direction to thereby acquire a spectroscopic image. The spectrometry apparatus is an apparatus that analyzes light intensity of each wavelength in each pixel of the spectroscopic image and measures a spectral spectrum. Meanwhile, in this embodiment, an example in which measurement target light reflected from the measurement target X is measured is shown. When a light emitting body such as, for example, a liquid crystal panel is used as the measurement target X, light emitted from the light emitting body may be used as the measurement target light.

Although not shown in the drawing, the spectrometry apparatus 1 also includes a relative movement mechanism that relatively moves the optical module 10 and the measurement target X. The relative movement mechanism may be configured so as to move, for example, a measurement head including an optical module with respect to the measurement target X or may be configured so as to move the measurement target X using, for example, a belt conveyor.

### Configuration of Optical Module

The optical module 10 includes a wavelength variable interference filter 5, a detector 11, an I-V converter 12, an amplifier 13, an A/D converter 14, and a driving control unit 15.

In the optical module 10, measurement target light reflected from the measurement target X passes through an incident optical system (not shown) and is guided to the wavelength variable interference filter 5, and the light having passed through the wavelength variable interference filter 5 is received by the detector 11 (light-receiving unit). A detected signal output from the detector 11 is output to the control unit 20 through the I-V converter 12, the amplifier 13, and the A/D converter 14.

### Configuration of Wavelength Variable Interference Filter

Next, the wavelength variable interference filter 5 incorporated in the optical module 10 will be described.

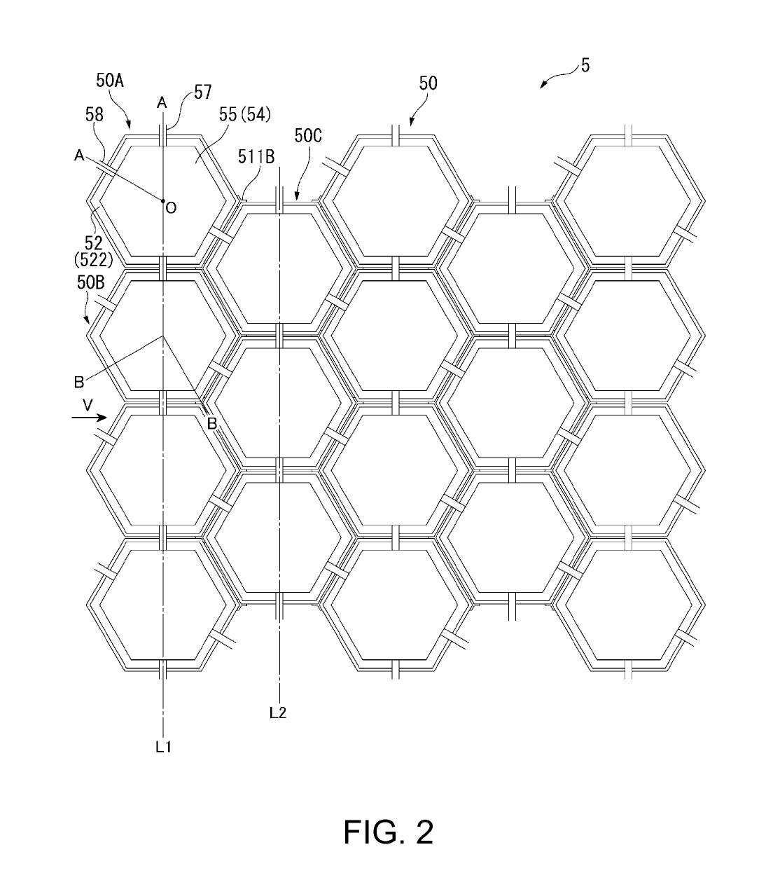

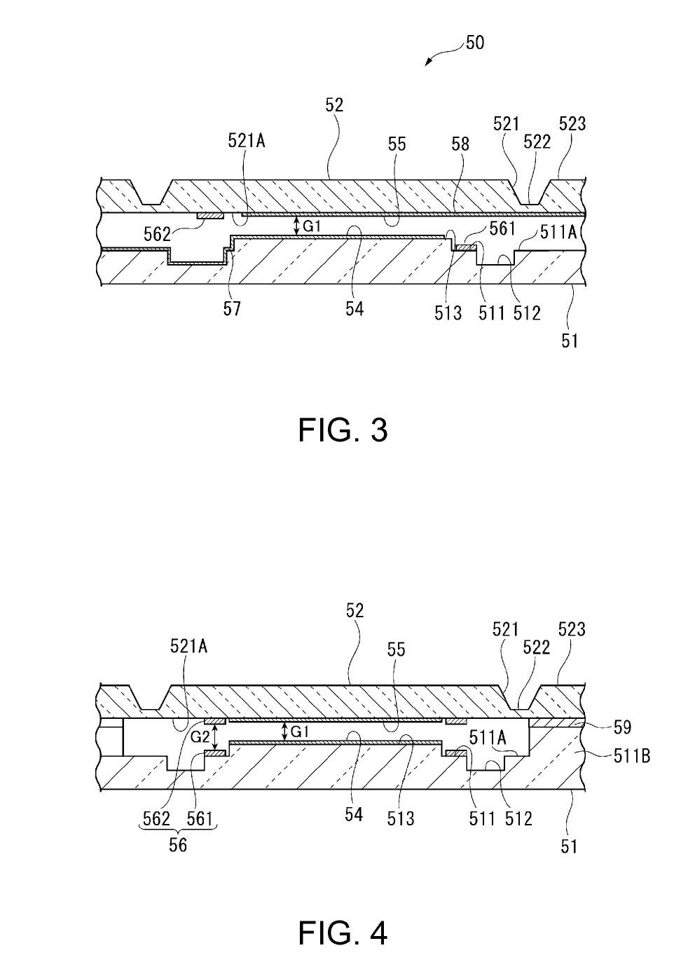

FIG. 2 is a plan view showing a schematic configuration of the wavelength variable interference filter according to the first embodiment. FIG. 3 is a cross-sectional diagram of the wavelength variable interference filter taken along line III-III of FIG. 2. FIG. 4 is a cross-sectional diagram of the wavelength variable interference filter taken along line IV-IV of FIG. 2.

As shown in FIG. 2, the wavelength variable interference filter 5 includes a plurality of filter units 50. Each of the plurality of filter units 50 has a shape that allows planar filling on an arrangement surface, and is constituted by, for example, a regular hexagon. The filter units are disposed so as to have a honeycomb structure on the arrangement surface.

Specifically, an arrangement structure of the filter units 50 will be described on the assumption that neighboring filter units disposed along a first virtual straight line L1, out of the plurality of filter units 50 which are two-dimensionally disposed, are a first filter unit 50A and a second filter unit 50B, respectively, and a filter unit disposed along a second virtual straight line L2 parallel to the first virtual straight line L1 is a third filter unit 50C. When mounting surfaces of the plurality of filter units 50 are scanned in a first direction V which intersects the first virtual straight line L1, reflecting films 54 and 55 of the third filter unit 50C are disposed between reflecting films 54 and 55 (see FIGS. 2 and 3) of the first filter unit 50A and reflecting films 54 and 55 of the second filter unit 50B, a portion of the reflecting films 54 and 55 of the first filter unit 50A and a portion of the reflecting films 54 and 55 of the third filter unit 50C are disposed so as to overlap each other, and a portion of the reflecting films 54 and 55 of the second filter unit 50B and a portion of the reflecting films 54 and 55 of the third filter unit 50C are disposed so as to overlap each other, when the first filter unit 50A, the second filter unit 50B, and the third filter unit 50C are seen from the first direction V.

That is, when the reflecting films 54 and 55 of the filter units 50 are projected to the first virtual straight line L1 with respect to the scanning direction (first direction V), the reflecting films 54 and 55 overlap each other and are disposed without gaps therebetween.

Each of the filter units 50 constituting the wavelength variable interference filter 5 mentioned above includes a fixed substrate 51 and a movable substrate 52 as shown in FIGS. 2, 3, and 4. The fixed substrate 51 and the movable substrate 52 are formed of various types of glass such as, for example, soda glass, crystalline glass, quartz glass, lead glass, potassium glass, borosilicate glass, and alkali-free glass, quartz crystal, or the like. The fixed substrate 51 and the movable substrate 52 are integrally formed by being bonded to each other using a bonding film 59 which is constituted by, for example, a plasma polymerization film containing siloxane as its main component.

The fixed reflecting film 54 constituting one of the pair of reflecting films according to the invention is provided on a surface of the fixed substrate 51 which faces the movable substrate 52, and the movable reflecting film 55 constituting the other one of the pair of reflecting films according to the invention is provided on a surface of the movable substrate 52 which faces the fixed substrate 51. The fixed reflecting film 54 faces the movable reflecting film 55 with a gap G1 interposed therebetween.

In addition, as shown in FIG. 4, the filter unit 50 is provided with an electrostatic actuator 56 (gap changing unit) which is used to adjust (change) the gap size of the gap G1. The electrostatic actuator 56 includes a fixed electrode 561 constituting a first electrode provided in the fixed substrate 51 and a movable electrode 562 constituting a second electrode provided in the movable substrate 52.

Meanwhile, in the following description, a plan view seen from a substrate thickness direction of the fixed substrate 51 or the movable substrate 52, that is, a plan view when the wavelength variable interference filter 5 is seen from a direction in which the fixed substrate 51 and the movable substrate 52 are laminated will be referred to as a filter plan view. In this embodiment, the center point of the fixed reflecting film 54 coincides with the center point of the movable reflecting film 55 when seen in a filter plan view, and the center points of the reflecting films 54 and 55 when seen in a plan view are indicated by O.

### Configuration of Fixed Substrate

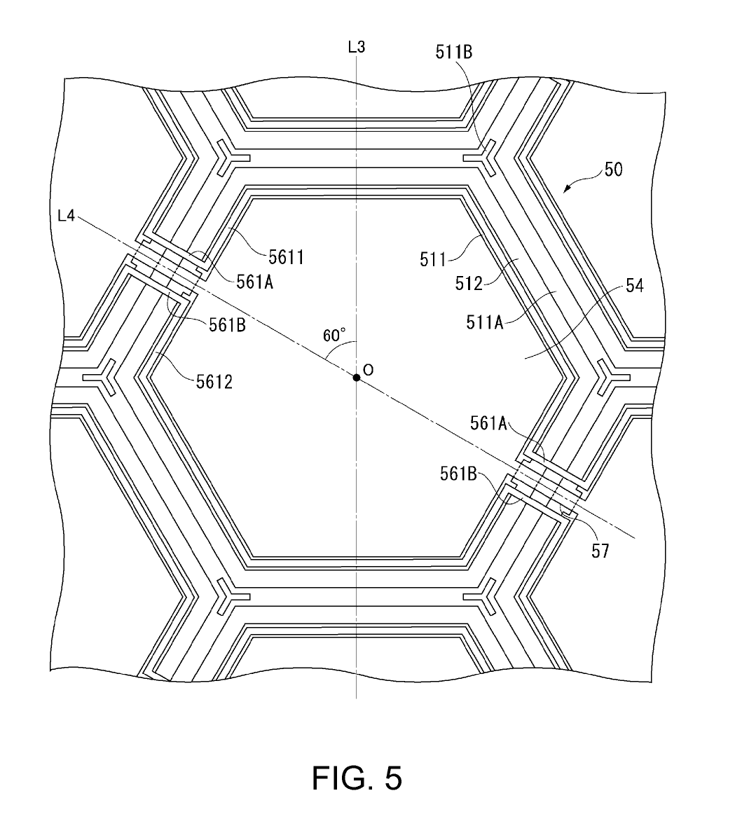

FIG. 5 is a plan view showing a schematic configuration of the fixed substrate of the wavelength variable interference filter according to this embodiment.

As shown in FIGS. 4 and 5, the fixed substrate 51 includes a first groove 511, a second groove 512, a third groove 511A, and a protrusion portion 513 which are formed by, for example, etching.

The first groove 511 is formed to have a regular hexagonal shape centering on a filter center point O of the fixed substrate 51 when seen in a filter plan view. The second groove 512 is a groove formed to have a substantially regular hexagonal shape centering on the filter center point O when seen in a filter plan view. The second groove is formed to have a larger depth than that of the first groove 511 and to be continuous with the outside of the first groove 511. In addition, a portion of the second groove 512 is formed to have a convex shape (wide width shape having a large groove width) on the protrusion portion 513 side when seen in a filter plan view, and a fixed mirror electrode 57 to be described later is disposed in the convex-shaped portion.

The third groove 511A is a groove continuous with the outside of the second groove 512 and having a groove bottom face which is located on the same plane as the groove bottom face of the first groove 511. The third groove 511A is formed along a side constituting an outer periphery in the filter unit 50 having a regular hexagonal shape. In addition, each of intersections (vertex positions) between the sides of the filter units 50 is provided with a bonding portion 511B erected from the third groove 511A. The bonding portions 511B are bonded to the movable substrate 52 using the bonding film 59.

Meanwhile, in the filter units 50 disposed at the outermost peripheral portions of the arrangement surface out of the plurality of filter units 50, the surfaces of the third grooves 511A are exposed to the outside to thereby constitute an electrical portion (not shown).

The fixed electrode 561 constituting the electrostatic actuator 56 is provided on the groove bottom face of the first groove 511. The fixed electrode 561 may be provided directly on the groove bottom face of the first groove 511, or may be provided on the groove bottom face with another thin film (layer) interposed therebetween.

Here, a straight line passing through the filter center point O of the filter unit 50, inclined at 60 degrees with respect to a virtual straight line L3 parallel to the first virtual straight line L1, and dividing the filter unit 50 into two parts is assumed to be a virtual straight line L4. The fixed electrode 561 includes a first partial fixed electrode 5611 which is disposed on one side of the first groove 511 with the virtual straight line L4 interposed therebetween, and a second partial fixed electrode 5612 which is disposed on the other side of the first groove 511 with the virtual straight line L4 interposed therebetween.

A first fixed extraction electrode 561A, extending to the third groove 511A along the virtual straight line L4 and connected to the first partial fixed electrode 5611 of the filter unit 50 adjacent thereto along the virtual straight line L4, is connected to both ends of the first partial fixed electrode 5611. Similarly, a second fixed extraction electrode 561B, extending to the third groove 511A along the virtual straight line L4 and connected to the second partial fixed electrode 5612 of the filter unit 50 adjacent thereto along the virtual straight line L4, is connected to both ends of the second partial fixed electrode 5612. In the wavelength variable interference filter 5, one ends of the fixed extraction electrodes 561A and 561B are connected to the driving control unit 15 in the electrical portion in the filter units 50 disposed at the outermost circumference.

In the electrical portion, the fixed extraction electrodes 561A and 561B which are connected to the first partial fixed electrode 5611 and the second partial fixed electrode 5612, respectively, which constitute one fixed electrode 561 are electrically connected to each other and are then connected to the driving control unit 15. Meanwhile, the driving control unit 15 may be configured such that the same voltage is applied to the fixed extraction electrodes 561A and 561B connected to the first partial fixed electrode 5611 and the second partial fixed electrode 5612, respectively, which constitute one fixed electrode 561.

Examples of a material constituting the fixed electrode 561 and the fixed extraction electrode 561A include a metal film such as Au, a metal laminate such as Cr/Au, and the like.

Meanwhile, this embodiment shows a configuration in which one fixed electrode 561 is provided on the groove bottom face of the first groove 511. However, for example, a configuration may be adopted in which two electrodes which are regular hexagons centering on the filter center point O are provided (dual electrode configuration).

The protrusion portion 513 is formed to have a regular hexagonal shape, and the fixed reflecting film 54 is provided on a surface of the protrusion portion which faces the movable substrate 52.

As shown in FIGS. 2, 3, 4, and 5, the fixed reflecting film 54 is formed to have a regular hexagonal shape which is the same as that of the protrusion portion 513 when seen in a filter plan view.

In addition, as shown in FIG. 3, the fixed reflecting film 54 is configured to include a dielectric multilayer film in which a high refractive index layer and a low refractive index layer are alternately laminated and a fixed conductive layer which is provided on the dielectric multilayer film and constitutes the outermost surface of the fixed reflecting film 54. That is, the fixed reflecting film 54 has conductivity. The dielectric multilayer film can include, for example, a laminated body in which TiO₂ is used as a high refractive index layer and SiO₂ is used as a low refractive index layer.

In addition, the fixed conductive layer is formed of a conductive metal oxide having light transmittance with respect to a wavelength region where measurement is performed using the spectrometry apparatus 1. Examples of a material of the fixed conductive layer include gallium indium oxide (InGaO), indium tin oxide (Sn-doped indium oxide: ITO), Ce-doped indium oxide (ICO), and fluorine-doped indium oxide (IFO) which are indium-based oxides, antimony-doped tin oxide (ATO), fluorine-doped tin oxide (FTO), and tin oxide (SnO₂) which are tin-based oxides, Al-doped zinc oxide (AZO), Ga-doped zinc oxide (GZO), fluorine-doped zinc oxide (FZO), and zinc oxide (ZnO) which are zinc-based oxides, and the like. In addition, indium zinc oxide (IZO: registered trademark) constituted by an indium-based oxide and a zinc-based oxide may be used.

In addition, as shown in FIG. 3, the fixed reflecting film 54 provided in the protrusion portion 513 of the fixed substrate 51 is provided with the fixed mirror electrode 57 which is contiguous with the conductive layer of the fixed reflecting film 54. The fixed mirror electrode 57, corresponding to a reflecting film connection electrode according to the invention, passes between the first fixed extraction electrode 561A and the second fixed extraction electrode 561B, is disposed along the first groove 511, the second groove 512, and the third groove 511A, and is connected to the conductive layer of the fixed reflecting film 54 of the filter unit 50 which is adjacent thereto along the virtual straight line L4. In the wavelength variable interference filter 5, one fixed mirror electrode 57 is extracted to the electrical portion and is connected to the driving control unit in the filter units 50 disposed at the outermost circumference.

Portions of the fixed mirror electrodes 57 which face the movable electrodes 562 are disposed along a portion of the second groove 512 mentioned above which has a wide width shape, and a gap therebetween is set to be larger than a gap between the fixed electrode 561 and the fixed electrode 562. That is, in the second groove 512, the fixed mirror electrode 57 faces the movable electrode 562, and thus it is possible to suppress the influence of electrostatic force generated due to a difference in potential between the fixed mirror electrode 57 and the movable electrode 562.

Meanwhile, an antireflection film may be formed at a location corresponding to the fixed reflecting film 54 on a light incident surface (surface on which the fixed reflecting film 54 is not provided) of the fixed substrate 51. For example, the antireflection film can be formed by alternately laminating a low refractive index film and a high refractive index film, and thus decreases the reflectance of visible light on the surface of the fixed substrate 51 and increases light transmittance.

### Configuration of Movable Substrate

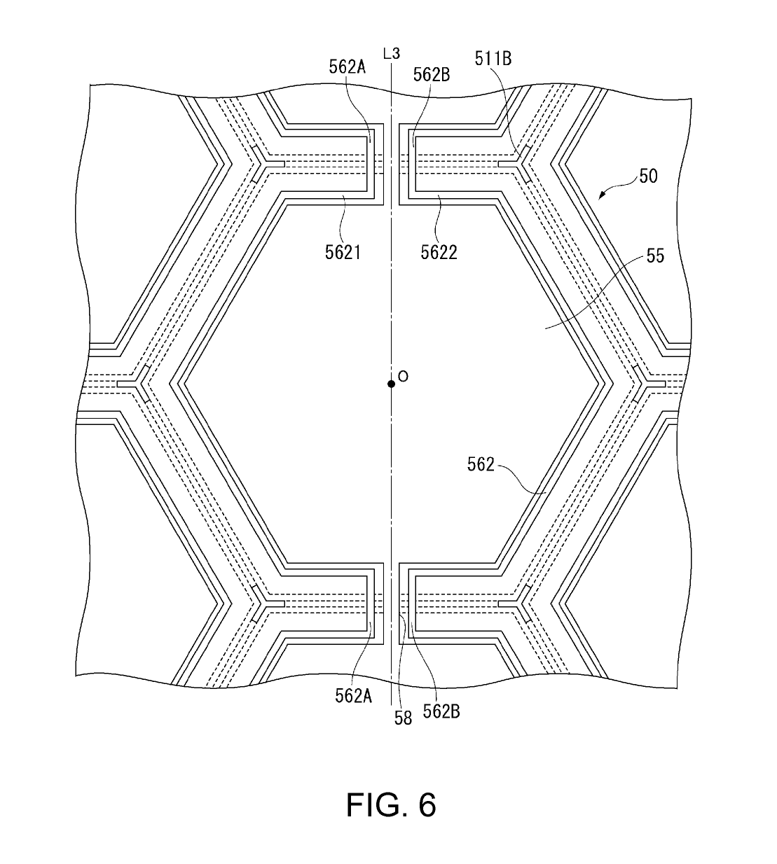

FIG. 6 is a plan view when the movable substrate 52 is seen from the fixed substrate 51 side.

As shown in FIGS. 2, 3, 4, and 6, the movable substrate 52 includes a movable portion 521 having a regular hexagonal shape centering on the filter center point O when seen in a filter plan view, a holding portion 522 that is formed coaxially with the movable portion 521 and holds the movable portion 521, and a connection portion 523 that is provided outside the holding portion 522.

Meanwhile, in the filter units 50 disposed at the outermost peripheral portion of the arrangement surface out of the plurality of filter units 50, the surfaces of the connection portions 523 are exposed to the outside to thereby constitute an electrical portion (not shown).

The movable portion 521 is formed to have a thickness larger than that of the holding portion 522. For example, in this embodiment, the movable portion is formed to have the same thickness as that of the movable substrate 52 (connection portion 523). The movable portion 521 is formed to have a larger diameter than at least a diameter of an outer peripheral edge of the fixed electrode 561 when seen in a filter plan view. The movable reflecting film 55 and the movable electrode 562 are provided on a movable surface 521A of the movable portion 521 which faces the fixed substrate 51. The movable reflecting film 55 and the movable electrode 562 may be provided directly on the movable surface 521A, or may be provided on another thin film (layer) provided on the movable surface 521A.

The movable electrode 562 and the fixed electrode 561 constitute the electrostatic actuator 56.

The movable electrode 562 includes a first partial movable electrode 5621 which is disposed on one side of the movable portion 521 with the virtual straight line L3 interposed therebetween, and a second partial movable electrode 5622 which is disposed on the other side of the movable portion 521 with the virtual straight line L3 interposed therebetween.

A first movable extraction electrode 562A, extending to the connection portion 523 side along the virtual straight line L3 and connected to the first partial movable electrode 5621 of the filter unit 50 adjacent thereto along the virtual straight line L3, is connected to both ends of the first partial movable electrode 5621. Similarly, a second movable extraction electrode 562B, extending to the connection portion 523 side along the virtual straight line L3 and connected to the second partial movable electrode 5622 of the filter unit 50 adjacent thereto along the virtual straight line L3, is connected to both ends of the second partial movable electrode 5622. In the wavelength variable interference filter 5, one ends of the movable extraction electrodes 562A and 562B are connected to the driving control unit 15 in the electrical portion in the filter units 50 which are disposed at the outermost circumference.

In the electrical portion, the movable extraction electrodes 562A and 562B connected to the first partial movable electrode 5621 and the second partial movable electrode 5622, respectively, which constitute one movable electrode 562 electrically communicate with each other and are then connected to the driving control unit 15. Meanwhile, similarly to the fixed electrode 561, the driving control unit 15 may be configured such that the same voltage is applied to the movable extraction electrodes 562A and 562B.

Meanwhile, similarly to the fixed electrode 561, examples of a material of the movable electrode 562 include a metal film such as Au, a metal laminate such as Cr/Au, and the like.

Meanwhile, in this embodiment, as shown in FIG. 3, a gap G2 between the fixed electrode 561 and the movable electrode 562 which constitute the electrostatic actuator 56 is larger than the gap G1 between the reflecting films 54 and 55, but the invention is not limited thereto. For example, a configuration may be adopted in which the gap G1 becomes larger than the gap G2 depending on a wavelength region of measurement target light such as a case where infrared radiation or far-infrared radiation is used as measurement target light.

The movable reflecting film 55 is provided in at least a region of the movable surface 521A which faces the fixed reflecting film 54, and faces the fixed reflecting film 54 with the predetermined gap G1 interposed therebetween. In addition, the movable reflecting film 55 has the same configuration as that of the fixed reflecting film 54, and is configured to include a dielectric multilayer film and a movable conductive layer which is provided on the dielectric multilayer film and constitutes the outermost surface of the movable reflecting film 55, as shown in FIG. 3. The dielectric multilayer film is constituted by, for example, a laminated body in which TiO₂ is used as a high refractive index layer and SiO₂ is used as a low refractive index layer. Similarly to the fixed conductive layer, the movable conductive layer is constituted by a conductive layer having light transmittance with respect to a wavelength region where measurement is performed using the spectrometry apparatus 1. Examples of a material of the movable conductive layer include gallium indium oxide (InGaO), indium tin oxide (Sn-doped indium oxide: ITO), Ce-doped indium oxide (ICO), and fluorine-doped indium oxide (IFO) which are indium-based oxides, antimony-doped tin oxide (ATO), fluorine-doped tin oxide (FTO), and tin oxide (SnO₂) which are tin-based oxides, Al-doped zinc oxide (AZO), Ga-doped zinc oxide (GZO), fluorine-doped zinc oxide (FZO), and zinc oxide (ZnO) which are zinc-based oxides, and the like. In addition, indium zinc oxide (IZO: registered trademark) constituted by indium-based oxide and zinc-based oxide, and the like may be used.

As shown in FIG. 3, in the movable reflecting film 55, a movable mirror electrode 58 is provided so as to be contiguous with the conductive layer of the movable reflecting film 55. The movable mirror electrode 58, corresponding to a reflecting film connection electrode according to the invention, passes between the first movable extraction electrode 562A and the second movable extraction electrode 562B and is connected to the conductive layer of the movable reflecting film 55 of the filter unit 50 which is adjacent thereto along the virtual straight line L3. In the wavelength variable interference filter 5, one movable mirror electrode 58 is extracted to the electrical portion and is connected to the driving control unit 15 in the filter units 50 disposed at the outermost circumference.

The holding portion 522 is a diaphragm that surrounds the vicinity of the movable portion 521, and is formed to have a smaller thickness than that of the movable portion 521. The holding portion 522 is more likely to bend than the movable portion 521, and thus it is possible to displace the movable portion 521 to the fixed substrate 51 side by slight electrostatic attraction. At this time, the movable portion 521 has a larger thickness than that of the holding portion 522 and thus has a higher rigidity. Accordingly, even when the movable portion 521 is pulled to the fixed substrate 51 side by electrostatic attraction, it is possible to suppress change in the shape of the movable portion 521 to some extent.

Meanwhile, the holding portion 522 having a diaphragm shape is illustrated in this embodiment, but the invention is not limited thereto. For example, a configuration may be adopted in which beam-like holding portions disposed at equal angular intervals are provided centering on the filter center point O of the movable portion 521.

### Configurations of Detector, I-V Converter, Amplifier, and A/D Converter of Optical Module

Next, the optical module 10 will be described with reference to FIG. 1 again.

The detector 11 receives (detects) light having passed through the wavelength variable interference filter 5 and outputs a detected signal based on the amount of received light to the I-V converter 12.

The I-V converter 12 converts the detected signal, which is input from the detector 11, into a voltage value and outputs the voltage value to the amplifier 13.

The amplifier 13 amplifies a voltage (detected voltage) based on the detected signal which is input from the I-V converter 12.

The A/D converter 14 converts the detected voltage (analog signal), which is input from the amplifier 13, into a digital signal and outputs the digital signal to the control unit 20.

### Configuration of Driving Control Unit

The driving control unit 15 includes a column driver circuit that controls a driving voltage to the fixed extraction electrodes 561A and 561B connected to the fixed electrode 561 of the filter unit 50 along the virtual straight line L4, that is, a driving voltage in a row direction, and a row driver circuit that controls a driving voltage to the movable extraction electrodes 562A and 562B connected to the movable electrode 562 of the filter unit 50 along the virtual straight line L3, that is, a driving voltage in a column direction. The driving control unit 15 selectively drives the filter units 50 by a passive matrix method using the column driver circuit and the row driver circuit.

Further, as described above, the driving control unit 15 connects the mirror electrodes 57 and 58 to a ground circuit and causes the reflecting films 54 and 55 to function as antistatic electrodes.

### Configuration of Control Unit

Next, the control unit 20 of the spectrometry apparatus 1 will be described.

The control unit 20 is configured so as to be combined with, for example, a CPU or a memory, and controls the overall operation of the spectrometry apparatus 1. As shown in FIG. 1, the control unit 20 includes a wavelength setting unit 21, a light quantity acquisition unit 22, and a spectrometry unit 23. In addition, the memory of the control unit 20 stores V-λ data indicating a relationship between a wavelength of light passing through the wavelength variable interference filter 5 and a driving voltage to be applied to the electrostatic actuator 56 in response to the wavelength.

The wavelength setting unit 21 sets a target wavelength of light extracted by the wavelength variable interference filter 5, and outputs a command signal for applying a driving voltage corresponding to the set target wavelength to the electrostatic actuator 56 to the driving control unit 15 on the basis of the V-λ data.

The light quantity acquisition unit 22 acquires the amount of light of a target wavelength which has passed through the wavelength variable interference filter 5, on the basis of the amount of light acquired by the detector 11.

The spectrometry unit 23 measures spectrum characteristics of measurement target light on the basis of the amount of light acquired by the light quantity acquisition unit 22.

### Operational Effects of First Embodiment

In this embodiment, the plurality of filter units 50 capable of changing a wavelength of light to be emitted are provided on the arrangement surface, the reflecting films 54 and 55 of the filter unit 50C on the second virtual straight line L2 are disposed between the reflecting films 54 and 55 in the two filter units 50A and 50B which are disposed so as to be adjacent to each other along the first virtual straight line L1 intersecting the first direction V (scanning direction), and the reflecting films 54 and 55 are disposed so as to overlap each other without gaps therebetween. That is, when the reflecting films 54 and 55 of the filter units 50 are projected to the first virtual straight line L1 from the scanning direction (first direction V) along a predetermined direction, the reflecting films 54 and 55 are disposed without gaps therebetween.

For this reason, when spectral dispersion is performed while relatively moving the wavelength variable interference filter 5 with respect to the measurement target X in the first direction V as a scanning direction, it is possible to perform spectrometry without a gap and to perform spectrometry with respect to a wide area.

In this embodiment, each of the plurality of filter units 50 is calibrated to have a regular hexagonal shape, and the filter units are disposed to have a planar filling structure (honeycomb structure) with respect to the arrangement surface. For this reason, even when the reflecting films are projected from any direction along the arrangement surface, the reflecting films 54 and 55 are disposed without gaps therebetween. Therefore, even when the wavelength variable interference filter 5 is relatively moved with respect to a measurement target in any scanning direction, spectrometry can be performed without a gap. In addition, it is possible to efficiently dispose the filter units by adopting a honeycomb structure.

In this embodiment, the bonding portions 511B are provided along the sides of the regular hexagonal shapes of the plurality of filter units 50. In such a configuration, the fixed substrate 51 and the movable substrate 52 are bonded to each other through the bonding portion 511B in each side of the regular hexagonal shape, and thus it is possible to achieve an improvement in bonding strength.

In this embodiment, the bonding portion 511B is provided at an intersection between the sides of the regular hexagonal shapes. In such a configuration, a bonding region between the fixed substrate 51 and the movable substrate 52 is minimized, and thus it is possible to improve area use efficiency in the wavelength variable interference filter 5. That is, it is possible to increase an area in which the reflecting films 54 and 55 are capable of being disposed and to transmit a sufficient amount of light from each of the filter units 50.

In this embodiment, each of the pair of reflecting films 54 and 55 of the plurality of filter units 50 is a regular hexagon corresponding to the shape of each of the filter units 50. In such a configuration, when an interval (gap G1) between the reflecting films 54 and 55 is changed using the electrostatic actuator 56, a portion in which there is a high probability of warpage or deflection being caused in the reflecting films 54 and 55 is limited to the vicinity of the vertex of the regular hexagon of each of the reflecting films 54 and 55. Therefore, an effective use area in which the reflecting film functions is increased, and thus it is possible to increase area use efficiency.

In this embodiment, the electrostatic actuator 56 includes the fixed electrode 561 provided in the fixed substrate 51 and the movable electrode 562 provided in the movable substrate 52. The fixed mirror electrode 57 and the movable mirror electrode 58 are connected to the fixed electrode 561 and the movable electrode 562, respectively, and are extracted up to a substrate outer peripheral portion.

In such a configuration, it is possible to change the gap G1 by individually driving the electrostatic actuators in the respective filter units 50 and to control a transmission wavelength for each pixel.

In this embodiment, a voltage is sequentially applied to the fixed mirror electrode 57 and the movable mirror electrode 58, and thus it is possible to drive the electrostatic actuators 56 using a passive matrix method. In this case, it is possible to individually drive the filter units 50 efficiently. In addition, an area occupied by a connection electrode can be reduced as compared with a case where connection electrodes are individually connected to the electrostatic actuators 56 of the filter units 50, and thus it is possible to increase areas of the fixed reflecting film 54 and the movable reflecting film 55 and to achieve an improvement in area efficiency.

In this embodiment, the fixed reflecting film 54 and the movable reflecting film 55 have conductivity and are connected to each other by the fixed mirror electrode 57 and the movable mirror electrode 58. The mirror electrodes 57 and 58 are connected to a ground circuit in the driving control unit 15. Thus, it is possible to allow charge of the reflecting films 54 and 55 to escape and to suppress the fluctuation of the gap between the reflecting films 54 and 55 due to Coulomb's forces and the like.

### Second Embodiment

Next, a second embodiment of the invention will be described with reference to the accompanying drawings.

In the first embodiment described above, an example has been shown in which the gaps G1 between the reflecting films 54 and 55 are the same in the filter units 50. On the other hand, the second embodiment is different from the first embodiment described above in that three types of filter unit having different gaps between reflecting films 54 and 55 are included. Meanwhile, the same components as those in the first embodiment described above are denoted by the same reference numerals and signs, and thus the description thereof will be omitted or simplified.

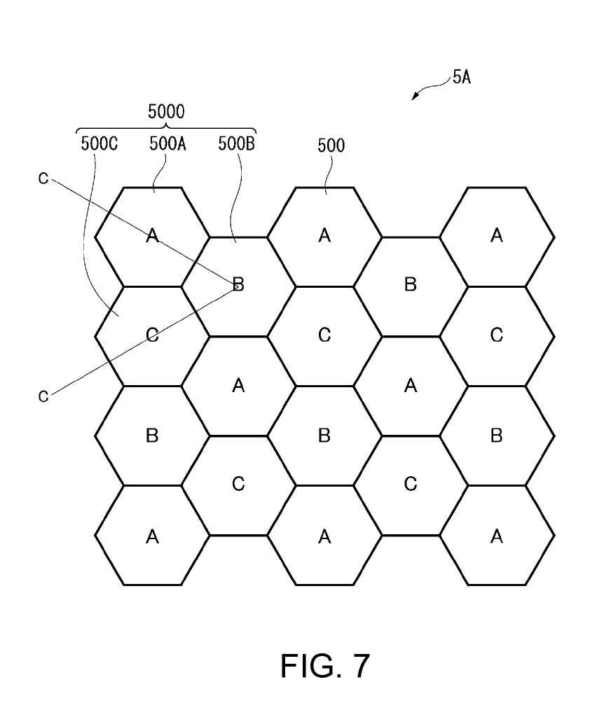

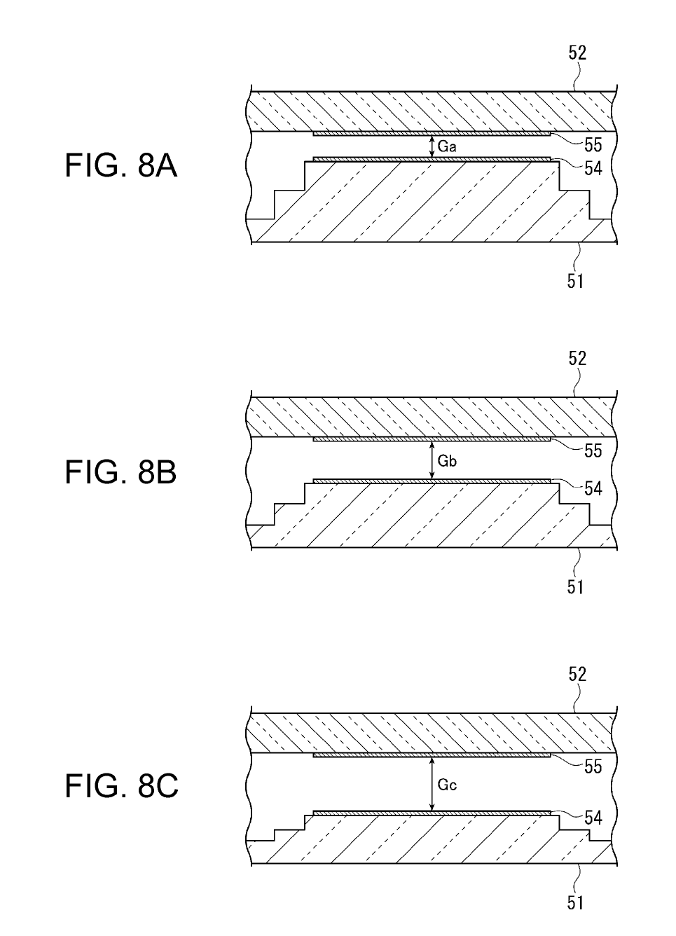

FIG. 7 is a plan view showing an example in which filter units of a wavelength variable interference filter according to the second embodiment are disposed. FIGS. 8A to 8C are cross-sectional diagrams showing a gap between the filter units.

A wavelength variable interference filter 5A according to the second embodiment includes a plurality of filter units 500. The plurality of filter units 500 include three types of filter units 500A, 500B, and 500C which have different initial sizes of gaps between the reflecting films 54 and 55. As shown in FIGS. 8A to 8C, a gap (interval) Ga between the fixed reflecting film 54 and the movable reflecting film 55 in the first filter unit 500A is smaller than a gap Gb between the fixed reflecting film 54 and the movable reflecting film 55 in the second filter unit 500B. In addition, the gap Gb between the fixed reflecting film 54 and the movable reflecting film 55 in the second filter unit 500B is smaller than a gap Gc between the fixed reflecting film 54 and the movable reflecting film 55 in the third filter unit 500C.

As described above, the gaps Ga, Gb, and Gc between the fixed reflecting film 54 and the movable reflecting film 55 in the respective filter units 500A, 500B, and 500C are different from each other, and thus wavelengths of light beams passing through the respective filter units 500A, 500B, and 500C are different from each other.

In this embodiment, the reflecting films 54 and 55 constituting the filter unit 500 are constituted by a dielectric multilayer film and initial sizes of the gaps therebetween are made different from each other. Thus, the first filter unit, the second filter unit, and the third filter unit are set to be capable of spectral resolution over wavelength scanning ranges of, for example, 400 nm to 500 nm, 500 nm to 600 nm, and 600 nm to 700 nm, respectively.

In addition, the first filter unit 500A, the second filter unit 500B, and the third filter unit 500C which constitute the wavelength variable interference filter 5A are disposed so that the same types of filter units 500 are not adjacent to each other as shown in FIG. 7. Accordingly, the filter units 500 with variable transmission wavelengths in the same band are not adjacent to each other, and thus it is possible to perform even spectral resolution of each band.

Here, as shown in FIG. 7, a set including each of the three types of filter units 500A, 500B, and 500C is assumed to be one pixel filter 5000. In the detector 11, an imaging element is set so that one pixel corresponds to each of the first filter unit 500A, the second filter unit 500B, and the third filter unit 500C which constitute the pixel filter 5000. Thus, it is possible to accurately acquire spectral characteristics at all wavelengths for one pixel. In addition, it is possible to derive a spectrum for one pixel of a spectroscopic image by joining pieces of data of the amounts of received light of the pixels provided with respect to the first filter unit 500A, the second filter unit 500B, and the third filter unit 500C, respectively. That is, it is possible to derive a spectrum having a wide band in which bandwidths of the filter units 500A, 500B, and 500C are integrated.

For example, in this embodiment, it is possible to individually drive the filter units 500 by driving the wavelength variable interference filter 5A using a passive matrix method. Therefore, when spectral characteristics in a wavelength scanning range of 400 nm to 500 nm are measured with respect to one pixel, a driving voltage is applied to the first filter unit 500A to sequentially acquire light beams having wavelengths within a range of 400 nm to 500 nm by the detector 11. Similarly, transmission wavelengths may be sequentially changed by driving the second filter unit 500B when a wavelength scanning range of 500 nm to 600 nm in each pixel is set as a target and driving the third filter unit 500C when a wavelength scanning range of 600 nm to 700 nm is set as a target, by using a passive matrix method.

### Operational Effects of Second Embodiment

In this embodiment, the multiple types of filter units 500A, 500B, and 500C having different initial sizes (initial gaps Ga, Gb, and Gc) for an interval between the pair of reflecting films 54 and 55 are provided. In such a configuration, the wavelength scanning ranges of the respective multiple types of filter units 500A, 500B, and 500C can be made different from each other, and thus it is possible to set a wide bandwidth for a spectroscopic object by using one wavelength variable interference filter 5A. For example, the first filter unit 500A having an initial gap of 700 nm between the reflecting films 54 and 55, the second filter unit 500B having an initial gap of 1000 nm therebetween, and the third filter unit 500C having an initial gap of 1300 nm therebetween may be used, and it is possible to spectrally resolve a wavelength region of 400 nm to 1300 nm by using one wavelength variable interference filter 5A when a wavelength scanning range of each of the filter units 500A, 500B, and 500C is 300 nm.

In this embodiment, since a dielectric multilayer film having high reflectance with respect to a predetermined wavelength region is used as the reflecting films 54 and 55, a half value width of light emitted from the wavelength variable interference filter 5A becomes smaller, and thus it is possible to improve resolution.

In addition, when a dielectric multilayer film is used as the reflecting films 54 and 55, a wavelength scanning range becomes narrow. However, as in the above-described embodiment, it is also possible to spectrally resolve a wide band by using the plurality of filter units 500A, 500B, and 500C having different initial gaps. Therefore, in this embodiment, it is possible to achieve both high resolution and a wide band.

### Other Embodiments

Meanwhile, the invention is not limited to the above-described embodiments, and modifications, improvements, and the like in a range capable of accomplishing the advantage of the invention are included in the invention.

In the first and second embodiments described above, the fixed reflecting film 54 and the movable reflecting film 55 are formed to have a hexagonal shape, but the invention is not limited thereto. For example, the fixed reflecting film 54 and the movable reflecting film 55 may be formed to have a circular shape. Accordingly, it is possible to reduce the warpage or deflection of the movable reflecting film 55 when the movable substrate 52 is deformed due to the driving of the electrostatic actuator 56 more than in a case where the fixed reflecting film 54 and the movable reflecting film 55 are formed to have a hexagonal shape.

Similarly, the fixed reflecting film 54 and the movable reflecting film 55 may be formed to have a triangular shape or a rectangular shape. In this regard, when the reflecting films 54 and 55 are formed to have a hexagonal shape according to the first and second embodiments described above, it is possible to further reduce the warpage or deflection of the movable reflecting film 55 as compared with a case where the reflecting films 54 and 55 are formed to have a triangular shape. That is, the reflecting films 54 and 55 are formed to have a hexagonal shape in the first and second embodiments described above, and thus it is possible to exhibit an effect more approximate to a case where the reflecting films 54 and 55 are formed to have a circular shape.

Meanwhile, in the first and second embodiments described above, a configuration has been illustrated in which the generation of Coulomb's forces is suppressed by setting the reflecting films 54 and 55 to a ground potential, but the invention is not limited thereto.

For example, a configuration may be adopted in which a high-frequency voltage is applied between the reflecting films 54 and 55 to detect capacitance between the reflecting films 54 and 55. In this case, feedback control of a voltage applied to the electrostatic actuator 56 is performed in accordance with the detected capacitance, and thus it is possible to more accurately control a gap size.

In addition, a driving voltage may be applied to the reflecting films 54 and 55 to thereby cause the reflecting films 54 and 55 to function as driving electrodes. In this case, it is possible to perform finer voltage control by using the electrostatic actuator 56 and the reflecting films 54 and 55, and thus the accuracy of gap control is improved.

Further, gap control may be performed by using only a voltage applied between the reflecting films 54 and 55 without providing the electrostatic actuator 56. In this case, the electrostatic actuator 56 and the extraction electrodes 561A, 561B, 562A, and 562B become unnecessary, and thus it is possible to simplify the configuration of the filter unit 50. Therefore, it is possible to increase areas of the reflecting films 54 and 55, and thus area efficiency is improved.

In the second embodiment, an example is shown in which the same dielectric multilayer film is used as the fixed reflecting film 54 and the movable reflecting film 55, which constitute each of the first filter unit 500A, the second filter unit 500B, and the third filter unit 500C, and the filter units have different initial sizes of a gap between the reflecting films 54 and 55, but the invention is not limited thereto. In the dielectric multilayer film, a film thickness of each dielectric film is designed so that reflectance increases with respect to a wavelength scanning range in which transmission is desired to be performed. As the total number of dielectric films increases, the reflectance in the dielectric multilayer film increases, and thus resolution in each filter unit 500 increases. Therefore, a configuration may be adopted in which the initial sizes of the gaps in the respective filter units 500A, 500B, and 500C are made different from each other by setting the number of films of each of the filter units 500A, 500B, and 500C to a predetermined number or more capable of securing a predetermined resolution and by making the numbers of films thereof different from each other. In this case, it is not necessary to make the sizes of protrusions of the protrusion portions 513 in the respective filter units 500A, 500B, and 500C different from each other, and thus it is possible to improve manufacturing efficiency at the time of manufacturing the fixed substrate 51.

Meanwhile, in the second embodiment, the first filter unit 500A, the second filter unit 500B, and the third filter unit 500C are constituted by a dielectric multilayer film, but the invention is not limited thereto. For example, the first filter unit 500A and the second filter unit 500B can be constituted by an Ag alloy, and the third filter unit 500C can be constituted by a dielectric multilayer film.

Meanwhile, in the spectrometry apparatus 1 according to the first and second embodiments, the wavelength variable interference filter 5 is configured so as to be directly provided in the optical module 10, but the invention is not limited thereto. For example, an optical filter device may be used in which an accommodation space is formed within a housing and the wavelength variable interference filter 5 is accommodated in the accommodation space. Accordingly, the wavelength variable interference filter 5 is protected by the housing, and thus it is possible to prevent the wavelength variable interference filter 5 from being damaged due to external factors.

A configuration has been illustrated in which the bonding portion 511B is provided at the vertex position of the regular hexagon of each filter unit 50, but the invention is not limited thereto. For example, a configuration may be adopted in which a bonding portion is provided at the center portion of each side of the regular hexagon.

In the embodiments described above, the spectrometry apparatus 1 is illustrated as the electronic device according to the invention, but the optical module and the electronic device according to the invention can be applied to various other fields.

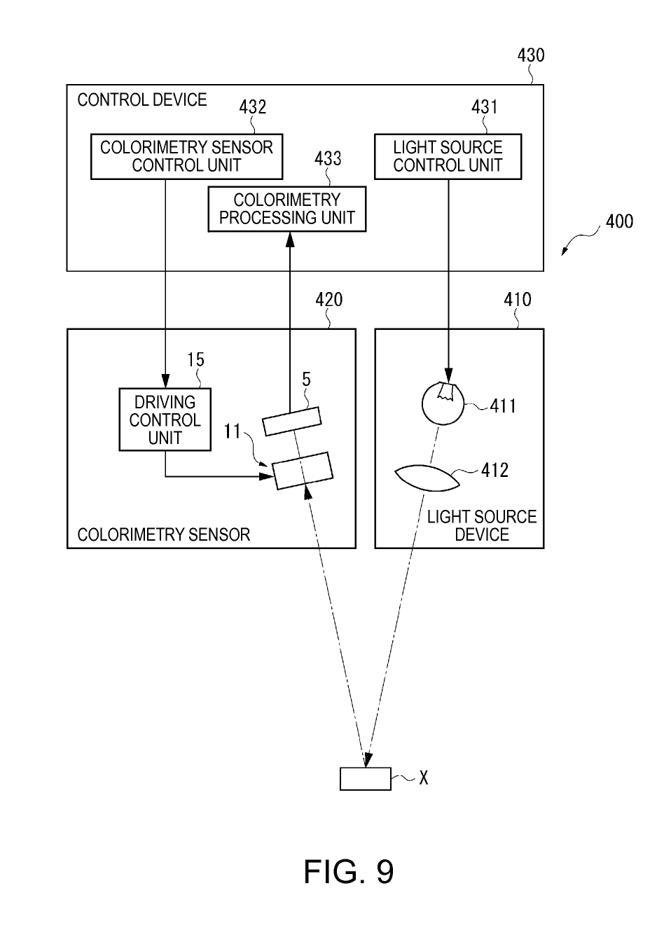

For example, as shown in FIG. 9, it is also possible to apply the electronic device according to the invention to a colorimeter for measuring color.

FIG. 9 is a block diagram showing an example of a colorimeter 400 including a wavelength variable interference filter.

As shown in FIG. 9, the colorimeter 400 include a light source device 410 that emits light to a measurement target X, a colorimetry sensor 420 (optical module), and a control device 430 that controls the overall operation of the colorimeter 400. The colorimeter 400 is an apparatus that causes light emitted from the light source device 410 to be reflected from the measurement target X, causes the reflected light to be tested to be received in the colorimetry sensor 420, and analyzes and measures the chromaticity of the light to be inspected, that is, the color of the measurement target X on the basis of a detected signal output from the colorimetry sensor 420.

The colorimeter includes the light source device 410, a light source 411, and a plurality of lenses 412 (only one lens is shown in FIG. 9), and emits, for example, reference light (for example, white light) to the measurement target X. In addition, the plurality of lenses 412 may include a collimator lens. In this case, the light source device 410 forms reference light emitted from the light source 411 into parallel light, and emits the parallel light toward the measurement target X from a projection lens not shown in the drawing. Meanwhile, in this embodiment, the colorimeter 400 including the light source device 410 is illustrated. However, for example, a configuration may be adopted in which the light source device 410 is not provided when the measurement target X is a light-emitting member such as a liquid crystal panel.

The colorimetry sensor 420, which is the optical module according to the invention, includes the wavelength variable interference filter 5, the detector 11 that receives light passing through the wavelength variable interference filter 5, and the driving control unit 15 which is capable of changing a wavelength of the light having passed through the wavelength variable interference filter 5, as shown in FIG. 9. In addition, the colorimetry sensor 420 includes an incident optical lens not shown in the drawing which guides reflected light (light to be inspected) reflected from the measurement target X to the inside, at a location facing the wavelength variable interference filter 5. The colorimetry sensor 420 spectrally resolves light of a predetermined wavelength, in the light to be inspected which is incident from the incident optical lens, by using the wavelength variable interference filter 5 and receives the dispersed light by the detector 11. Meanwhile, a configuration may be adopted in which an optical filter device is provided instead of the wavelength variable interference filter 5.

The control device 430 controls the overall operation of the colorimeter 400.

For example, a general-purpose personal computer, a portable information terminal, and a computer exclusively for colorimetry can be used as the control device 430. As shown in FIG. 9, the control device 430 is configured to include a light source control unit 431, a colorimetry sensor control unit 432, a colorimetry processing unit 433, and the like.

The light source control unit 431 is connected to the light source device 410 and outputs a predetermined control signal to the light source device 410 on the basis of, for example, a user's setting input to thereby emit white light having a predetermined brightness.

The colorimetry sensor control unit 432 is connected to the colorimetry sensor 420, sets a wavelength of light received by the colorimetry sensor 420 on the basis of, for example, a user's setting input, and outputs a control signal for detecting the amount of received light of the wavelength to the colorimetry sensor 420. Thus, the driving control unit 15 of the colorimetry sensor 420 applies a voltage to the electrostatic actuator 56 on the basis of the control signal to thereby drive the wavelength variable interference filter 5.

The colorimetry processing unit 433 analyzes the chromaticity of the measurement target X from the amount of received light which is detected by the detector 11.

In addition, a light-based system for detecting the presence of a specific material is an example of another example of the electronic device according to the invention. Such a system can include a gas detector such as, for example, an in-car gas leakage detector that detects a specific gas with high sensitivity by adopting a spectroscopic measurement method using the optical module according to the invention or a photoacoustic noble gas detector for breath testing.

An example of such a gas detector will be described below with reference to the accompanying drawings.

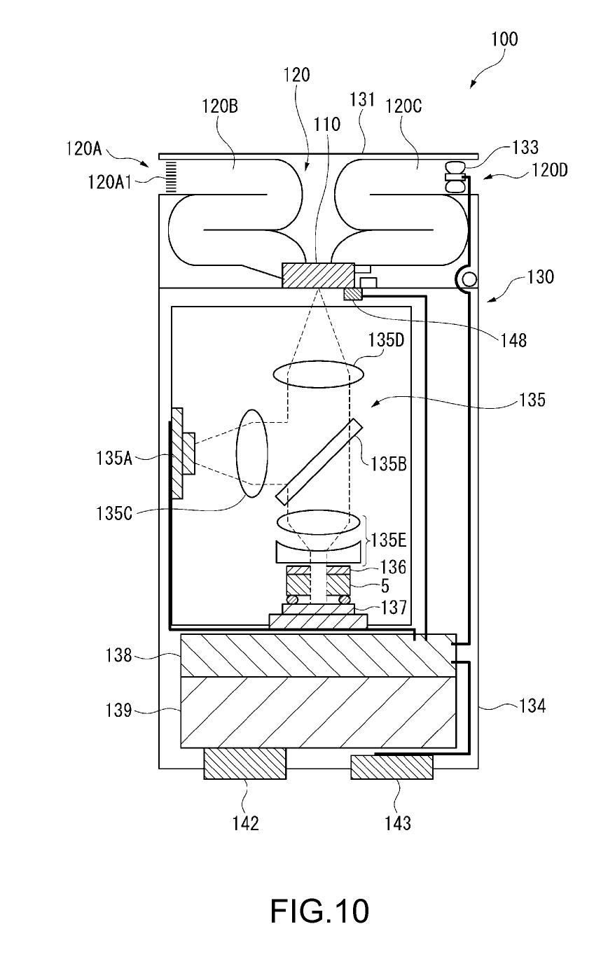

FIG. 10 is a schematic diagram showing an example of a gas detector including the optical module according to the invention.

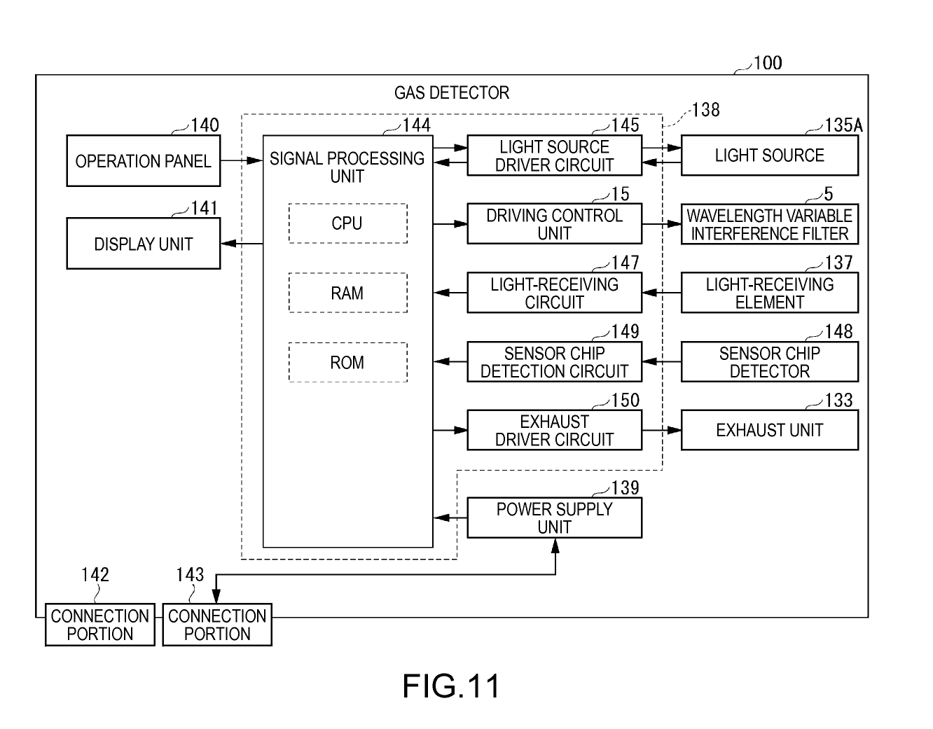

FIG. 11 is a block diagram showing the configuration of a control system of the gas detector of FIG. 10.

As shown in FIG. 10, the gas detector 100 is configured to include a flow channel 120 and a main body portion 130. The flow channel includes a sensor chip 110, a suction port 120A, a suction flow channel 120B, an exhaust flow channel 120C, and an exhaust port 120D.

The main body portion 130 includes a detection device (optical module), a control unit 138 (processing unit), a power supply unit 139, and the like. The detection device includes a sensor unit cover 131 having an opening capable of detaching the flow channel 120, an exhaust unit 133, a housing 134, an optical portion 135, a filter 136, a wavelength variable interference filter 5, a light-receiving element 137 (light-receiving unit), and the like. The control unit processes a signal output based on light received in a light-receiving element 137 and controls the detection device and a light source unit. The power supply unit supplies power. Meanwhile, a configuration may be adopted in which an optical filter device is provided instead of the wavelength variable interference filter 5. In addition, the optical portion 135 includes a light source 135A that emits light, a beam splitter 135B that reflects light incident from the light source 135A to the sensor chip 110 side and transmits the light incident from the sensor chip side to the light-receiving element 137 side, and lenses 135C, 135D, and 135E.

In addition, as shown in FIG. 11, an operation panel 140, a display unit 141, a connection portion 142 for an interface with the outside, and a power supply unit 139 are provided on the surface of the gas detector 100. When the power supply unit 139 is a secondary battery, a connection portion 143 for charging may be provided.

Further, as shown in FIG. 11, the control unit 138 of the gas detector 100 includes a signal processing unit 144 constituted by a CPU or the like, a light source driver circuit 145 for controlling the light source 135A, a driving control unit 15 for controlling the wavelength variable interference filter 5, a light-receiving circuit 147 that receives a signal from the light-receiving element 137, a sensor chip detection circuit 149 that receives a signal from the sensor chip detector 148 for reading a code of the sensor chip 110 and detecting the presence or absence of the sensor chip 110, an exhaust driver circuit 150 that controls the exhaust unit 133, and the like.

Next, operations of the gas detector 100 as mentioned above will be described below.

The sensor chip detector 148 is provided inside the sensor unit cover 131 located at the upper portion of the main body portion 130, and the presence or absence of the sensor chip 110 is detected by the sensor chip detector 148. When a detected signal from the sensor chip detector 148 is detected, the signal processing unit 144 determines that the sensor chip 110 is mounted, and outputs a display signal for displaying an executable detection operation on the display unit 141.

When the operation panel 140 is operated by, for example, a user, and an instruction signal for starting a detection process is output from the operation panel 140 to the signal processing unit 144, first, the signal processing unit 144 causes the light source driver circuit 145 to operate the light source 135A by outputting a light source operation signal. When the light source 135A is driven, stable laser light of linearly polarized light of a single wavelength is emitted from the light source 135A. In addition, the light source 135A has a temperature sensor or a light amount sensor built-in, and its information is output to the signal processing unit 144. When it is determined that the light source 135A is operating stably on the basis of the temperature or the amount of light which is input from the light source 135A, the signal processing unit 144 controls the exhaust driver circuit 150 and brings the exhaust unit 133 into operation. Thus, a gaseous sample including a target substance (gas molecules) to be detected is induced from the suction port 120A to the suction flow channel 120B, the inside of the sensor chip 110, the exhaust flow channel 120C, and the exhaust port 120D. Meanwhile, the suction port 120A is provided with a dust filter 120A1, and relatively large dust particles, some vapor and the like are removed.

In addition, the sensor chip 110 is a sensor, having a plurality of metal nanostructures built-in, in which localized surface plasmon resonance is used. In such a sensor chip 110, when an enhanced electric field is formed between metal nanostructures by laser light, and gas molecules gain entrance into the enhanced electric field, Raman scattering light including information on molecular vibrations and Rayleigh scattering light are generated.

The Rayleigh scattering light and the Raman scattering light are incident on the filter 136 through the optical portion 135, the Rayleigh scattering light is split by the filter 136, and the Raman scattering light is incident on the wavelength variable interference filter 5. The signal processing unit 144 outputs a control signal to the driving control unit 15. Thus, the driving control unit 15 drives the electrostatic actuator 56 of the wavelength variable interference filter 5 in the same manner as in the first embodiment and spectrally resolves the Raman scattering light corresponding to gas molecules to be detected using the wavelength variable interference filter 5. Thereafter, when the spectrally resolved light is received in the light-receiving element 137, a light receiving signal according to the amount of light received is output to the signal processing unit 144 through the light-receiving circuit 147. In this case, it is possible to accurately extract Raman scattering light as a target from the wavelength variable interference filter 5.

The signal processing unit 144 compares spectral data of the Raman scattering light corresponding to the gas molecules to be detected which are obtained as stated above with data stored in a ROM, determines whether they are target gas molecules, and identifies substances. In addition, the signal processing unit 144 causes the display unit 141 to display result information thereof, or outputs the result information from the connection portion 142 to the outside.

Meanwhile, in FIGS. 10 and 11, the gas detector 100 is illustrated in which the Raman scattering light is spectrally resolved by the wavelength variable interference filter 5 and a gas is detected from the spectrally resolved Raman scattering light. In addition, the gas detector may be used as a gas detector that identifies a gas type by detecting absorbance inherent in a gas. In this case, a gas sensor that causes a gas to flow into a sensor and detects light absorbed by a gas in the incident light is used as the optical module according to the invention. A gas detector that analyzes and identifies the gas flowing into the sensor using such a gas sensor is used as the electronic device according to the invention. In such a configuration, it is also possible to detect gas components using the wavelength variable interference filter.

In addition, as a system for detecting the presence of a specific substance, a substance component analyzer such as a noninvasive measurement device for saccharides using near-infrared spectroscopy, or a noninvasive measurement device for obtaining information on food, living organisms, and minerals can be used without being limited to the gas detection as mentioned above.

Hereinafter, a food analyzer will be described as an example of the above-mentioned substance component analyzer.

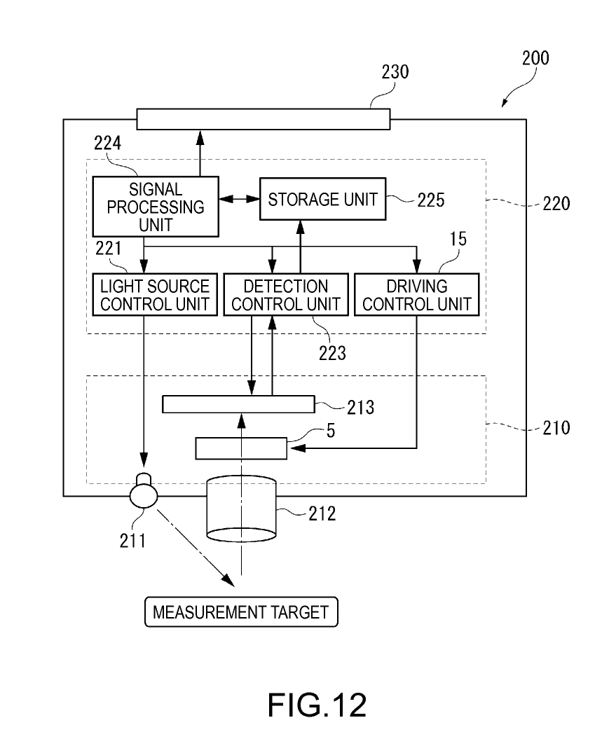

FIG. 12 is a diagram showing a schematic configuration of a food analyzer which is an example of the electronic device using the optical module according to the invention.

As shown in FIG. 12, a food analyzer 200 includes a detector 210 (optical module), a control unit 220, and a display unit 230. The detector 210 includes a light source 211 that emits light, an imaging lens 212 into which light from a measurement target is introduced, the wavelength variable interference filter 5 that spectrally resolves light introduced from the imaging lens 212, and an imaging unit 213 (light-receiving unit) that detects spectrally resolved light. Meanwhile, a configuration may be adopted in which an optical filter device is provided instead of the wavelength variable interference filter 5.

In addition, the control unit 220 includes a light source control unit 221 that performs turn-on and turn-off control of the light source 211 and brightness control at the time of turn-on, the driving control unit 15 that controls the wavelength variable interference filter 5, a detection control unit 223 that controls the imaging unit 213 and acquires a spectroscopic image which is imaged by the imaging unit 213, a signal processing unit 224, and a storage unit 225.

The food analyzer 200 is configured such that when the system is driven, the light source 211 is controlled by the light source control unit 221, and light is applied from the light source 211 to a measurement target. Light reflected from the measurement target is incident on the wavelength variable interference filter 5 through the imaging lens 212. The wavelength variable interference filter 5 is driven using the driving method as mentioned in the first embodiment under the control of the driving control unit 15. Thus, it is possible to accurately extract light of a target wavelength from the wavelength variable interference filter 5. The extracted light is imaged by the imaging unit 213 constituted by, for example, a CCD camera. In addition, the imaged light is stored in the storage unit 225 as a spectroscopic image. In addition, the signal processing unit 224 changes a voltage value applied to the wavelength variable interference filter 5 by controlling the driving control unit 15, and acquires a spectroscopic image for each wavelength.

The signal processing unit 224 arithmetically processes data of each pixel in each image accumulated in the storage unit 225, and obtains a spectrum in each pixel. In addition, for example, information on components of food regarding the spectrum is stored in the storage unit 225. The signal processing unit 224 analyzes data of the obtained spectrum on the basis of the information on the food stored in the storage unit 225, and obtains food components included in the object to be detected and the content thereof. In addition, food calories, freshness and the like can be calculated from the obtained food components and content. Further, by analyzing a spectral distribution within the image, it is possible to extract a portion in which freshness deteriorates in food to be inspected, and to detect foreign substances or the like included in the food.

The signal processing unit 224 performs a process of displaying information such as the components, the content, calories, freshness and the like of the food to be inspected which are obtained as mentioned above, on the display unit 230.

In addition, in FIG. 12, an example of the food analyzer 200 is illustrated, but the food analyzer can also be used as the above-mentioned noninvasive measurement device for other information using substantially the same configuration. For example, the food analyzer can be used as a living organism analyzer that analyzes living body components, for example, measures and analyzes body fluid components such as blood. Such a living body analyzer is used as a device that measures, for example, body fluid components such as blood. When the analyzer is used as a device that detects ethyl alcohol, the analyzer can be used as an anti-drink-driving device that detects the drinking condition of a driver. In addition, the analyzer can also be used as an electronic endoscope system including such a living body analyzer.

Further, the analyzer can also be used as a mineral analyzer that performs a component analysis of minerals.

Further, the optical module and the electronic device according to the invention can be applied to the following devices.

For example, it is also possible to transmit data using the light of each wavelength by temporally changing the intensity of the light of each wavelength. In this case, light of a specific wavelength is spectrally resolved by the wavelength variable interference filter provided in the optical module, and is received in the light-receiving unit, thereby allowing data transmitted by the light of a specific wavelength to be extracted. The data of the light of each wavelength is processed by the electronic device including such an optical module for data extraction, and thus it is also possible to perform optical communication.

In addition, the electronic device can also be applied to a spectroscopic camera, a spectroscopic analyzer and the like that image a spectroscopic image by spectral resolving of light using the optical module according to the invention. An example of such a spectroscopic camera includes an infrared camera having a wavelength variable interference filter built-in.

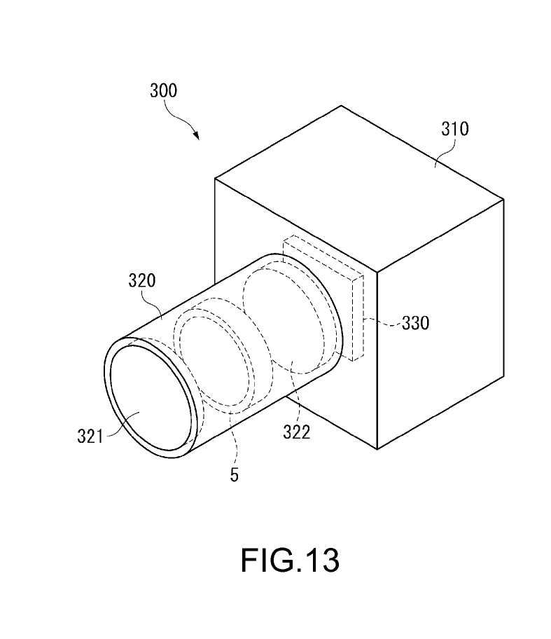

FIG. 13 is a schematic diagram showing a schematic configuration of a spectroscopic camera. As shown in FIG. 13, a spectroscopic camera 300 includes a camera body 310, an imaging lens unit 320, and an imaging unit 330.

The camera body 310 is a portion which is held and operated by a user.

The imaging lens unit 320 is provided in the camera body 310, and guides incident image light to the imaging unit 330. In addition, as shown in FIG. 13, the imaging lens unit 320 includes an objective lens 321, an image forming lens 322, and the wavelength variable interference filter 5 which is provided between these lenses. Meanwhile, a configuration may be adopted in which an optical filter device is provided instead of the wavelength variable interference filter 5.

The imaging unit 330 is constituted by a light-receiving element, and images image light guided by the imaging lens unit 320.

In such a spectroscopic camera 300, it is possible to image a spectroscopic image of light of a desired wavelength by transmitting light of a wavelength serving as an imaging object using the wavelength variable interference filter 5.

Further, the optical module according to the invention may be used as a band pass filter, and may be used as, for example, an optical laser device in which only narrow-band light centered on a predetermined wavelength in light of a predetermined wavelength region which is emitted by the light-emitting element is spectrally resolved and transmitted using the wavelength variable interference filter.

In addition, the optical module according to the invention may be used as a living body authentication device, and may also be applied to, for example, an authentication device using blood vessels, a fingerprint, a retina, an iris and the like using light of a near-infrared region or a visible region.

Further, the optical module and the electronic device can be used as a concentration detector. In this case, infrared energy (infrared light) emitted from a substance is spectrally resolved and analyzed by the wavelength variable interference filter, and the concentration of a test object in a sample is measured.

As described above, the optical module and the electronic device according to the invention can also be applied to any device that spectrally resolves predetermined light from incident light. As described above, since the optical module according to the invention can spectrally resolve a wide area while maintaining high resolution, it is possible to accurately perform the measurement of a spectrum of a plurality of wavelengths, and the detection of a plurality of components. Therefore, as compared to a device of the related art that extracts a desired wavelength using a plurality of devices, a reduction in the size of the optical module or the electronic device can be promoted, and the optical module or the electronic device can be suitably used in, for example, a portable or in-car optical device.

In addition, a specific structure at the time of carrying out the invention may be appropriately changed to other structures or the like in a range capable of achieving the advantage of the invention.

The entire disclosure of Japanese Patent Application No. 2013-248931 filed on Dec. 2, 2013 is expressly incorporated by reference herein.

What is claimed is:

1. A wavelength variable interference filter comprising:
a plurality of filter units each of which includes a pair of reflecting films facing each other and a gap changing unit changing an interval between the pair of reflecting films,
wherein the plurality of filter units are two-dimensionally disposed with respect to an arrangement surface parallel to a reflecting surface of the reflecting film, and reflecting films of other filter units disposed at locations different from those on a first virtual straight line, intersecting a predetermined direction along the arrangement surface, are disposed so as to overlap a portion of the reflecting films on the first virtual straight line without gaps therebetween between two reflecting films adjacent with a predetermined interval therebetween along the first virtual straight line, when seen from the predetermined direction.

2. The wavelength variable interference filter according to claim 1, wherein the plurality of filter units are disposed so as to have a planar filling structure when seen from a direction perpendicular to the arrangement surface.

3. The wavelength variable interference filter according to claim 2, wherein each of the plurality of filter units has a regular hexagonal shape in a planar view seen from the direction perpendicular to the arrangement surface, and the filter units are disposed so as to have a honeycomb structure as the planar filling structure.

4. The wavelength variable interference filter according to claim 3,
wherein each of the plurality of filter units includes a first substrate on which one of the pair of reflecting films is provided, a second substrate on which the other one is provided, and a bonding portion that bonds the first substrate and the second substrate, and
wherein the bonding portion is provided along sides of the regular hexagonal shape of each of the filter units.

5. The wavelength variable interference filter according to claim 4, wherein the bonding portion is provided at an intersection between the sides of the regular hexagonal shape.

6. The wavelength variable interference filter according to claim 3, wherein each of the pair of reflecting films of each of the plurality of filter units has a regular hexagonal shape corresponding to the regular hexagonal shape of each of the filter units in a planar view seen from the direction perpendicular to the arrangement surface.

7. The wavelength variable interference filter according to claim 1, wherein the plurality of filter units include multiple types of filter unit having different initial sizes for an interval between the pair of reflecting films.

8. The wavelength variable interference filter according to claim 1, wherein each of the pair of reflecting films is constituted by a dielectric multilayer film.

9. The wavelength variable interference filter according to claim 1,
wherein each of the plurality of filter units includes a first substrate on which one of the pair of reflecting films is provided, and a second substrate on which the other one is provided,
wherein the gap changing unit includes a first electrode provided in the first substrate, and a second electrode which is provided in the second substrate and faces the first electrode,
wherein the first substrate is provided with a first connection electrode connected to the first electrode, and the first connection electrode is provided from the first electrode to a substrate outer peripheral portion of the first substrate, and
wherein the second substrate is provided with a second connection electrode connected to the second electrode, and the second connection electrode is provided from the second electrode to a substrate outer peripheral portion of the second substrate.

10. The wavelength variable interference filter according to claim 9,
wherein the first connection electrode connects the first electrodes of the respective filter units which are disposed along a predetermined first direction in a planar view seen from the direction perpendicular to the arrangement surface, and
wherein the second connection electrode connects the second electrodes of the respective filter units which are disposed along a second direction intersecting the first direction in a planar view seen from the direction perpendicular to the arrangement surface.

11. The wavelength variable interference filter according to claim 1,
wherein each of the pair of reflecting films has conductivity, and
wherein a reflecting film connection electrode is connected to each of the reflecting films.

12. An optical module comprising:
a wavelength variable interference filter according to claim 1; and
a light-receiving unit that receives light emitted from the wavelength variable interference filter.

13. The optical module according to claim 12,
wherein the plurality of filter units include multiple types of filter unit having different initial sizes for an interval between the pair of reflecting films, and sets each including a predetermined number of multiple types of filter unit are disposed in a matrix as pixel filters on the arrangement surface, and
wherein the light-receiving unit is provided with a plurality of pixels corresponding to each of the multiple types of filter unit of each of the pixel filters.

14. An electronic device comprising:
a wavelength variable interference filter according to claim 1; and
a control unit that controls the wavelength variable interference filter.

15. A wavelength variable interference filter comprising: a first filter unit having a first reflecting film, a second reflecting film opposing to the first reflecting film, and a first gap changing unit changing a first gap between the first reflecting film and the second reflecting film;
a second filter unit having a third reflecting film, a fourth reflecting film opposing to the third reflecting film, and a second gap changing unit changing a second gap between the third reflecting film and the fourth reflecting film; and
a third filter unit having a fifth reflecting film, a sixth reflecting film opposing to the fifth reflecting film, and a third gap changing unit changing a third gap between the fifth reflecting film and the sixth reflecting film,
the first reflecting film and the third reflecting film arranging in a first direction,
when looking from a second direction crossing to the first direction, the fifth reflecting film overlapping to the first reflection film and the third reflection film.
